(19) United States
(12) Patent Application Publication
(10) Pub. No.: US 2011/0122668 A1
(43) Pub. Date: May 26, 2011

(54) CAPACITOR ENERGY RELEASE CIRCUIT WITH REDUCED POWER CONSUMPTION AND POWER SUPPLY HAVING THE SAME

(75) Inventors: Cheng-Yi Lo, Taoyuan Hsien (TW); Chen-Te Lin, Taoyuan Hsien (TW)

(73) Assignee: DELTA ELECTRONICS, INC., Taoyuan Hsien (TW)

(21) Appl. No.: 12/948,553

(22) Filed: Nov. 17, 2010

(30) Foreign Application Priority Data
Nov. 20, 2009 (TW) 098139629

(51) Int. Cl. H02M 7/06

(52) U.S. Cl. 363/126

(57) ABSTRACT

A power source includes a power input terminal, a filtering unit, a main circuit and a capacitor energy release circuit. The power input terminal receives an AC voltage. The filtering unit is connected to the power input terminal for filtering off noise contained in the AC voltage. The main circuit is connected to the filtering unit and a load. The AC voltage is filtered by the filtering unit and converted into an output DC voltage by the main circuit, and the output DC voltage is transmitted to the load. The capacitor energy release circuit is connected to the power input terminal, the filtering unit and a common terminal for detecting whether the AC voltage is received by the power input terminal. When the AC voltage is not received by the power input terminal, electric energy stored in the filtering unit is discharged.

### FIELD OF THE INVENTION

The present invention relates to a release circuit, and more particularly to a capacitor energy release circuit with reduced power consumption. The present invention also relates to a power supply having such a capacitor energy release circuit.

### BACKGROUND OF THE INVENTION

Nowadays, a power supply becomes essential to many electronic devices such as a computer, a server, or the like. The power supply may receive an input voltage from a power source (e.g. a utility source) and convert the input voltage into a regulated DC voltage required for powering an electronic device.

FIG. 1 is a schematic circuit diagram illustrating a conventional power supply. As shown in FIG. 1, the power supply 1 comprises a main circuit 10, which is interconnected between an AC power source and a load 11. By the main circuit 10, an AC voltage from the AC power source is rectified into a transition DC voltage. According to the working voltage of the load 11, the transition DC voltage is converted into a specified-level DC voltage for powering the load 11.

In addition, the power supply 1 also has a filter capacitor C₁. The filter capacitor C₁ is connected to the input side of the power supply 1 in parallel. The use of the filter capacitor C₁ may filter off the high-frequency noise contained in the AC voltage in order to reduce the problem of causing electromagnetic interference.

According to safety regulations of electronic devices, the electric energy stored in the filter capacitor C₁ should be quickly discharged in order to prevent from getting an electric shock. As shown in FIG. 1, the conventional power supply 1 has a discharging resistance R₁. The discharging resistance R₁ and the filter capacitor C₁ are connected with each other in parallel, thereby forming a discharging loop. In a case that the connection between the power supply 1 and the AC power source is interrupted and the AC voltage is not received by the power supply 1, the energy stored in the filter capacitor C₁ should be quickly discharged within a time constant, which is equal to the product of the capacitance value of the filter capacitor C₁ multiplied by the discharging resistance R₁. As such, the power supply 1 may comply with the safety regulations.

Although the conventional power supply 1 may comply with the safety regulations, there are still some drawbacks. For example, since discharging resistance R₁ and the filter capacitor C₁ are connected to each other in parallel, the discharging loop is continuously defined by the discharging resistance R₁ even if the AC voltage is received by the power supply 1 without the need of discharging electric energy. In other words, when the power supply is normally operated to receive the AC voltage, the discharging resistance R₁ may consume much power because of the impedance property thereof. Since the power supply fails to meet the power-saving requirement, the power supply needs to be further improved.

Therefore, there is a need of providing a capacitor energy release circuit with reduced power consumption so as to obviate the drawbacks encountered from the prior art.

### SUMMARY OF THE INVENTION

The present invention relates to a capacitor energy release circuit with reduced power consumption so as to meet the power-saving requirement.

The present invention also relates to a power supply having such a capacitor energy release circuit.

In accordance with an aspect of the present invention, there is provided a power supply. The power source includes a power input terminal, a filtering unit, a main circuit and a capacitor energy release circuit. The power input terminal receives an AC voltage. The filtering unit is connected to the power input terminal for filtering off noise contained in the AC voltage. The main circuit is connected to the filtering unit and a load. The AC voltage is filtered by the filtering unit and converted into an output DC voltage by the main circuit, and the output DC voltage is transmitted to the load. The capacitor energy release circuit is connected to the power input terminal, the filtering unit and a common terminal for detecting whether the AC voltage is received by the power input terminal. When the AC voltage is not received by the power input terminal, electric energy stored in the filtering unit is discharged.

In accordance with another aspect of the present invention, there is provided a power supply. The power supply is interconnected between an AC power source and a load. The power source outputs an AC voltage. The power source includes a power input terminal, a filtering unit, a main circuit and a capacitor energy release circuit. The power input terminal receives the AC voltage. The filtering unit is connected to the power input terminal for filtering off noise contained in the AC voltage. The main circuit is connected to the filtering unit and the load, and includes a rectifying circuit. The AC voltage is filtered by the filtering unit and converted into an output DC voltage by the main circuit. The rectifying circuit is connected to the filtering unit for rectifying the AC voltage into a transition DC voltage. The capacitor energy release circuit is connected to the power input terminal, the filtering unit and a common terminal for detecting whether the AC voltage is received by the power input terminal. When the AC voltage is not received by the power input terminal, electric energy stored in the filtering unit is discharged.

In accordance with a further aspect of the present invention, there is provided a capacitor energy release circuit for use in a power supply. The power supply has a power input terminal connected to an AC power source and has a filtering unit. The capacitor energy release circuit includes a switching circuit, a discharging circuit and a discharging loop controller. The switching circuit includes a first current-conducting terminal and a second current-conducting terminal. The second current-conducting terminal is connected to a common terminal. The discharging circuit is connected to the filtering unit and the first current-conducting terminal of the switching circuit. When the switching circuit is conducted, electric energy stored in the filtering unit is discharged by the discharging circuit. The discharging loop controller is connected to the power input terminal and a control terminal of the switching circuit for detecting whether the AC voltage is received by the power input terminal. Under control of the discharging loop controller, the switching circuit is shut off if the AC voltage is received by the power input terminal, or the switching circuit is conducted if the AC voltage is not received by the power input terminal.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a conventional power supply;

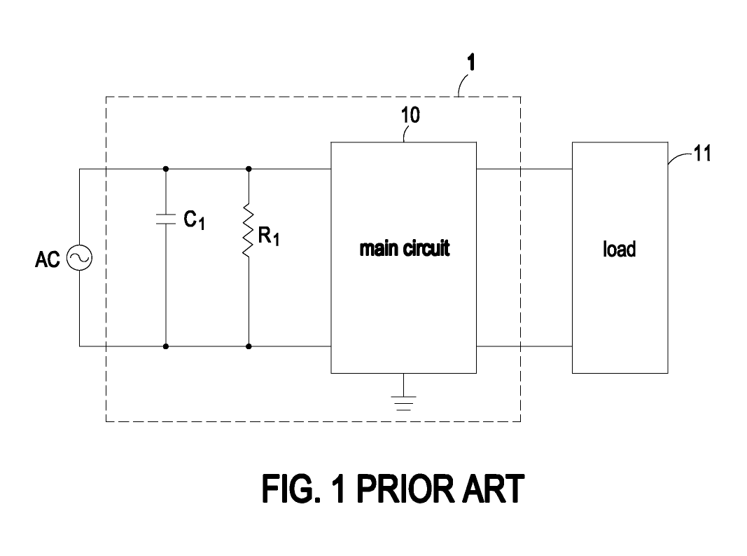

FIG. 2 is a schematic circuit diagram illustrating a power supply according to a first embodiment of the present invention;

FIG. 3 is a schematic detailed circuit diagram illustrating the power supply as shown in FIG. 2;

FIG. 4 is a schematic detailed circuit diagram illustrating a power supply according to a second embodiment of the present invention;

FIG. 5 is a schematic detailed circuit diagram illustrating a power supply according to a third embodiment of the present invention; and

FIG. 6 is a schematic detailed circuit diagram illustrating a power supply according to a fourth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

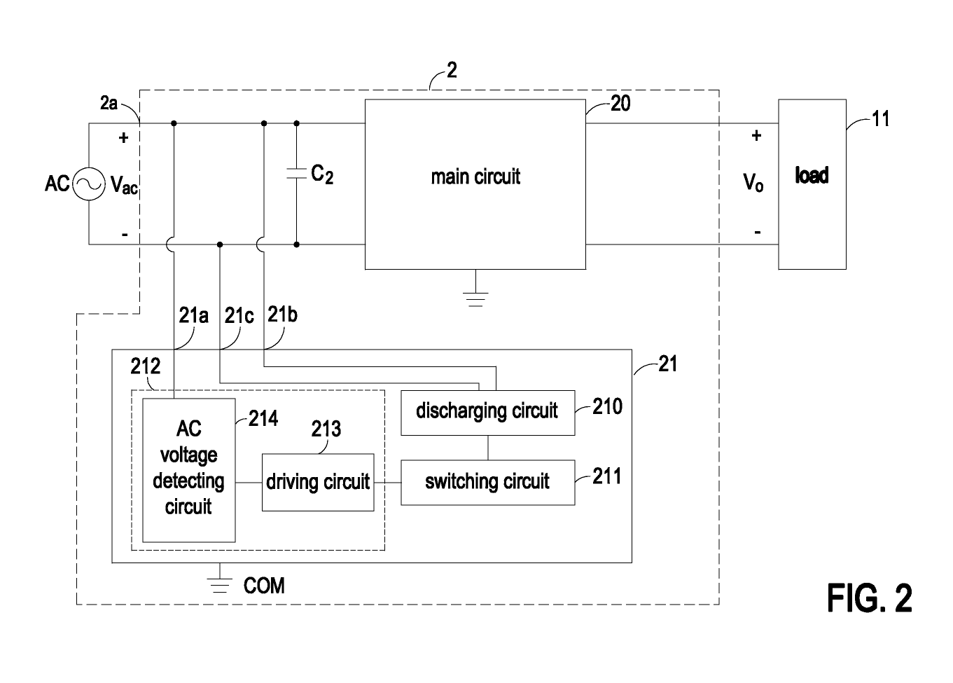

FIG. 2 is a schematic circuit diagram illustrating a power supply according to a first embodiment of the present invention. As shown in FIG. 2, the power supply 2 is interconnected between an AC power source and a load 11. The AC power source may output an AC voltage V_{ac}. By the power supply 2, the AC voltage V_{ac} is rectified and converted into an output DC voltage Vₒ required for powering the load 11. The power supply 2 comprises a power input terminal 2a, a filtering unit, a main circuit 20 and a capacitor energy release circuit 21.

In this embodiment, the filtering unit includes a filter capacitor C₂, which is connected to the AC power source. The use of the filter capacitor C₂ may filter off the high-frequency noise contained in the AC voltage V_{ac} in order to reduce the problem of causing electromagnetic interference. The main circuit 20 in interconnected between the filter capacitor C₂ and the load 11. The AC voltage V_{ac} is filtered by the filter capacitor C₂, and then rectified and converted into the output DC voltage Vₒ by the main circuit 20.

In this embodiment, the capacitor energy release circuit 21 comprises a detecting terminal 21a, a first discharging terminal 21b and a second discharging terminal 21c. The detecting terminal 21a is connected to the power input terminal 2a of the power supply 2. The first discharging terminal 21b and the second discharging terminal 21c are respectively connected to the positive terminal and the negative terminal of the filter capacitor C₂. The capacitor energy release circuit 21 is connected to a common terminal COM. Via the detecting terminal 21a, the capacitor energy release circuit 21 can detect whether the AC voltage V_{ac} is received by the power input terminal 2a of the power supply 2. Once the detecting results indicates that the AC voltage V_{ac} is not received by the power input terminal 2a, a discharging loop is defined by the filter capacitor C₂ and the common terminal COM. As such, the electric energy stored in the filter capacitor C₂ is discharged to the discharging loop through the first discharging terminal 21b and the second discharging terminal 21c.

That is, the discharging loop is only created when the capacitor energy release circuit 21 detects that the AC voltage V_{ac} is not received by the power input terminal 2a. The electric energy stored in the filter capacitor C₂ may be quickly discharged to the discharging loop so as to meet the safety regulations.

On the other hand, once the AC voltage V_{ac} is normally received by the power input terminal 2a, the filter capacitor C₂ will be normally charged. In this situation, no discharging loop is defined by the capacitor energy release circuit 21. As such, the AC voltage V_{ac} is no longer consumed by the capacitor energy release circuit 21. In other words, since the discharging loop is dynamically created by the capacitor energy release circuit 21, the power consumption of the power supply 2 is reduced in order to enhance the power-saving efficacy.

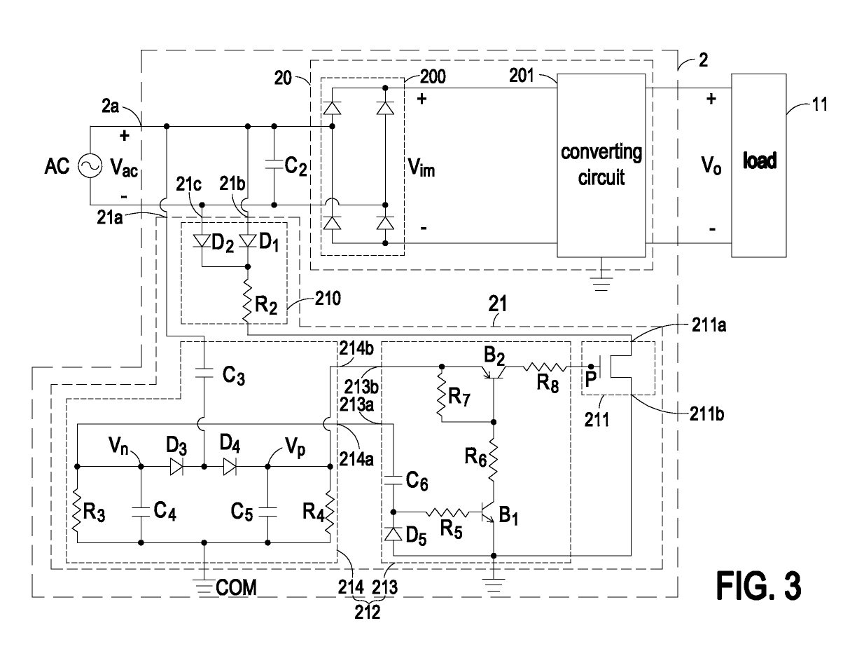

FIG. 3 is a schematic detailed circuit diagram illustrating the power supply as shown in FIG. 2. As shown in FIG. 3, the main circuit 20 comprises a rectifying circuit 200 and a converting circuit 201. An example of the rectifying circuit 200 included but is not limited to a bridge rectifier. The rectifying circuit 200 is connected to the filter capacitor C₂ in parallel. The AC voltage V_{ac} is filtered by the filter capacitor C₂, and then rectified into a transition DC voltage Vᵢₘ by the rectifying circuit 200. The converting circuit 201 is interconnected between the rectifying circuit 200 and the load 11. According to the working voltage required for powering the load 11, the transition DC voltage Vᵢₘ is converted into the output DC voltage Vₒ.

The capacitor energy release circuit 21 comprises a discharging circuit 210, a switching circuit 211 and a discharging loop controller 212. The switching circuit 211 is implemented by a junction field effect transistor (JFET). In views of cost-effectiveness, the switching circuit 211 is implemented by a metal oxide semiconductor field effect transistor (MOSFET). Alternatively, the switching circuit 211 is implemented by an N-type transistor. The switching circuit 211 is serially connected between the discharging circuit 210 and the common terminal COM. That is, the switching circuit 211 has a first current-conducting terminal 211a and a second current-conducting terminal 211b, which are respectively connected to the discharging circuit 210 and the common terminal COM.

The discharging circuit 210 comprises a first discharging terminal 21b and a second discharging terminal 21c, which are respectively connected to both terminals of the filter capacitor C₂. That is, the first discharging terminal 21b and the second discharging terminal 21c are respectively connected to a positive input terminal and a negative input terminal of the filter capacitor C₂. When the switching circuit 211 is conducted, the electric energy stored in the filter capacitor C₂ is discharged by the discharging circuit 210. In this embodiment, the discharging circuit 210 comprises a first discharging diode D₁, a second discharging diode D₂ and a discharging resistor R₂. The anode of the first discharging diode D₁ is connected to the positive input terminal of the filter capacitor C₂ through the first discharging terminal 21b. The anode of the second discharging diode D₂ is connected to the negative input terminal of the filter capacitor C₂ through the second discharging terminal 21c. The cathode of the first discharging diode D₁ and the cathode of the second discharging diode D₂ are connected to a first terminal of the discharging resistor R₂. A second terminal of the discharging resistor R₂ is connected to the first current-conducting terminal 211a of the switching circuit 211. The first discharging diode D₁ and the second discharging diode D₂ are used for rectifying. When the switching circuit 211 is conducted, the electric energy stored in the filter capacitor C₂ is discharged by the discharging resistor R₂ because of the impedance property of the discharging resistor R₂.

The discharging loop controller 212 comprises a driving circuit 213 and an AC voltage detecting circuit 214. The AC voltage detecting circuit 214 comprises a detecting terminal 21a, a first output terminal 214a and a second output terminal 214b. The detecting terminal 21a is connected to the power input terminal 2a of the power supply 2. The first output terminal 214a and the second output terminal 214b are respectively connected to a first input terminal 213a and a second input terminal 213b of the driving circuit 213. The AC voltage detecting circuit 214 is used for detecting whether the AC voltage V_{ac} is received by the power input terminal 2a of the power supply 2. According to the detecting result, the AC voltage detecting circuit 214 generates a first detecting signal Vₙ (negative) at the first output terminal 214a and a second detecting signal Vₚ (positive) at the second output terminal 214b.

In this embodiment, the AC voltage detecting circuit 214 comprises a first voltage-dividing capacitor C₃, a second voltage-dividing capacitor C₄, a third voltage-dividing capacitor C₅, a first rectifying diode D₃ and a second rectifying diode D₄. A first terminal of the first voltage-dividing capacitor C₃ is connected to the detecting terminal 21a, and connected to the power input terminal 2a of the power supply 2 through the detecting terminal 21a. A second terminal of the first voltage-dividing capacitor C₃ is connected to the cathode of the first rectifying diode D₃ and the anode of the second rectifying diode D₄. The anode of the first rectifying diode D₃ is connected to the second rectifying diode D₄ and the first output terminal 214a. The cathode of the second rectifying diode D₄ is connected to the third voltage-dividing capacitor C₅ and the second output terminal 214b. The second rectifying diode D₄ and the third voltage-dividing capacitor C₅ are also connected to the common terminal COM.

If the AC voltage V_{ac} is received by the power input terminal 2a of the power supply 2 during the positive half-cycle period, the AC voltage V_{ac} passes through the first voltage-dividing capacitor C₃ and the second rectifying diode D₄ to charge the third voltage-dividing capacitor C₅. As such, the third voltage-dividing capacitor C₅ generates the second detecting signal Vₚ (positive). Whereas, if the AC voltage V_{ac} is received by the power input terminal 2a of the power supply 2 during the negative half-cycle period, the AC voltage V_{ac} passes through the first voltage-dividing capacitor C₃ and the first rectifying diode D₃ to charge the second voltage-dividing capacitor C₄. As such, the second voltage-dividing capacitor C₄ generates the first detecting signal Vₙ (negative).

In some embodiments, the AC voltage detecting circuit 214 further comprises a first voltage-regulating resistor R₃ and a second voltage-regulating resistor R₄. The first voltage-regulating resistor R₃ is connected to the second voltage-dividing capacitor C₄ in parallel for regulating the voltage level of the first detecting signal Vₙ. The second voltage-regulating resistor R₄ is connected to the third voltage-dividing capacitor C₅ in parallel for regulating the voltage level of the second detecting signal Vₚ.

Please refer to FIG. 3 again. The first input terminal 213a and the second input terminal 213b of the driving circuit 213 are respectively connected to the first output terminal 214a and the second output terminal 214b of the AC voltage detecting circuit 214. In addition, the driving circuit 213 is further connected to a control terminal P of the switching circuit 211 and the common terminal COM. According to the first detecting signal Vₙ, the operations of the switching circuit 211 are controlled by the driving circuit 213. In a case that the voltage level of the first detecting signal Vₙ is maintained at a negative value, the driving circuit 213 discriminates that the AC voltage V_{ac} is received by the power input terminal 2a of the power supply 2. As such, the switching circuit 211 is shut off under control of the driving circuit 213. Whereas, in a case that the voltage level of the first detecting signal Vₙ is increased from the negative value to zero, the driving circuit 213 discriminates that the AC voltage V_{ac} is not received by the power input terminal 2a of the power supply 2. Meanwhile, the second detecting signal Vₚ outputted from the AC voltage detecting circuit 214 is transmitted to the control terminal P of the switching circuit 211 through the driving circuit 213. In response to the second detecting signal Vₚ, the switching circuit 211 is conducted.

In this embodiment, the driving circuit 213 comprises a pulse capacitor C₆, a voltage-difference diode D₅, an NPN bipolar junction transistor B₁, a PNP bipolar junction transistor B₂, a first current-limiting resistor R₅ and a second current-limiting resistor R₆. The pulse capacitor C₆ is connected to the first output terminal 214a of the AC voltage detecting circuit 214 for receiving the first detecting signal Vₙ. In addition, the pulse capacitor C₆ is also connected to the first current-limiting resistor R₅ and the anode of the voltage-difference diode D₅. In a case that the AC voltage V_{ac} is not received by the power input terminal 2a of the power supply 2, the first detecting signal Vₙ is converted into a positive pulse by the pulse capacitor C₆.

The anode of the voltage-difference diode D₅ is connected to the emitter of the NPN bipolar junction transistor B₁ and the common terminal COM. The first current-limiting resistor R₅ is connected to the base of the NPN bipolar junction transistor B₁. The first current-limiting resistor R₅ is used for limiting the current flowing into the base of the NPN bipolar junction transistor B₁. The emitter of the NPN bipolar junction transistor B₁ is also connected to the common terminal COM. The collector of the NPN bipolar junction transistor B₁ is connected to the second current-limiting resistor R₆. The second current-limiting resistor R₆ is connected to the base of the PNP bipolar junction transistor B₂. The second current-limiting resistor R₆ is used for limiting the current flowing into the base of the PNP bipolar junction transistor B₂. The emitter of the PNP bipolar junction transistor B₂ is connected to the second input terminal 213b of the driving circuit 213. The emitter of the PNP bipolar junction transistor B₂ is also connected to the second output terminal 214b of the AC voltage detecting circuit 214 through the second input terminal 213b. The emitter of the PNP bipolar junction transistor B₂ is used for receiving the second detecting signal Vₚ. The collector of the switching circuit 211 is connected to the control terminal P of the switching circuit 211.

In some embodiments, the driving circuit 213 further comprises a third voltage-regulating resistor R₇ and a fourth voltage-regulating resistor R₈. Both terminals of the third voltage-regulating resistor R₇ are respectively connected to the emitter and the base of the PNP bipolar junction transistor B₂. The third voltage-regulating resistor R₇ is used for stabilizing operations of the PNP bipolar junction transistor B₂. Both terminals of the fourth voltage-regulating resistor R₈ are respectively connected to the collector of the PNP bipolar junction transistor B₂ and the control terminal P of the switching circuit 211. The fourth voltage-regulating resistor R₈ is used for stabilizing operations of the switching circuit 211.

Hereinafter, the operating principles of the capacitor energy release circuit 21 of the power supply 2 will be illustrated in more details with reference to FIGS. 2 and 3. In a case that the AC voltage V_{ac} is received by the power input terminal 2a of the power supply 2, the AC voltage V_{ac} will charge the filter capacitor C₂ and thus electric energy is stored in the filter capacitor C₂. At the same time, the main circuit 20 provides the output DC voltage Vₒ to the load 11. Moreover, during the positive half-cycle period of the AC voltage V_{ac}, the AC voltage V_{ac} provides a forward pulse current. The forward pulse current flows through the first voltage-dividing capacitor C₃ and the second rectifying diode D₄ to charge the third voltage-dividing capacitor C₅. As such, the third voltage-dividing capacitor C₅ generates the second detecting signal Vₚ (positive). Whereas, during the negative half-cycle period of the AC voltage V_{ac}, the AC voltage V_{ac} provides a backward pulse current. The backward pulse current flows through the first voltage-dividing capacitor C₃ and the first rectifying diode D₃ to charge the second voltage-dividing capacitor C₄. As such, the second voltage-dividing capacitor C₄ generates the first detecting signal Vₙ (negative).

At the same time, the first detecting signal Vₙ whose voltage level is maintained at the negative value will pass through the pulse capacitor C₆ and the first current-limiting resistor R₅, so that the NPN bipolar junction transistor B₁ is driven to be in an off state. Since the NPN bipolar junction transistor B₁ is in the off state, the voltage difference between the emitter and the base of the PNP bipolar junction transistor B₂ is smaller than the on voltage of the PNP bipolar junction transistor B₂, the PNP bipolar junction transistor B₂ will also be in the off state. Under this circumstance, the switching circuit 211 fails to be conducted and thus in the off state. That is, the discharging resistor R₂ of the discharging circuit 210 fails to constitute a loop. As such, when the AC voltage V_{ac} is received by the power supply 2, the power consumption of the capacitor energy release circuit 21 is largely reduced. In comparison with the conventional power supply, the power supply 2 of the present invention has reduced power consumption.

In a case that the AC voltage V_{ac} is not received by the power input terminal 2a of the power supply 2, the electric energy stored in the second voltage-dividing capacitor C₄ and the third voltage-dividing capacitor C₅ will be discharged. As such, the voltage level of the first detecting signal Vₙ is increased from the negative value to zero and the voltage level of the second detecting signal Vₚ is decreased from the positive value to zero. Due to a level change of the first detecting signal Vₙ, a positive pulse signal is generated by the pulse capacitor C₆. The positive pulse signal is transmitted to the NPN bipolar junction transistor B₁ through the first current-limiting resistor R₅. In response to the positive pulse signal, the NPN bipolar junction transistor B₁ is conducted. Since the NPN bipolar junction transistor B₁ is conducted, the voltage difference between the emitter and the base of the PNP bipolar junction transistor B₂ is greater than the on voltage of the PNP bipolar junction transistor B₂. As such, the PNP bipolar junction transistor B₂ is also conducted, and the second detecting signal Vₚ generated by the third voltage-dividing capacitor C₅ will be transmitted to the control terminal P of the switching circuit 211 through the PNP bipolar junction transistor B₂. In response to the second detecting signal Vₚ, the switching circuit 211 is conducted, and thus a discharging circuit is defined by the discharging resistor R₂ of the discharging circuit 210 and the switching circuit 211. As such, the electric energy stored in the filter capacitor C₂ will be quickly discharged. In other words, the power supply 2 of the present invention may meet the safety regulations.

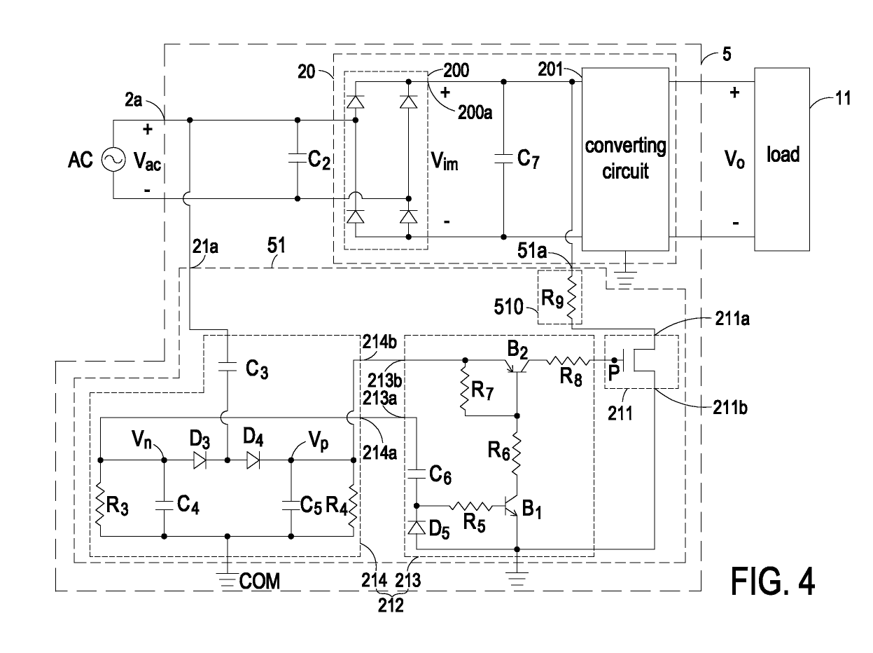

FIG. 4 is a schematic detailed circuit diagram illustrating a power supply according to a second embodiment of the present invention. In comparison with FIG. 3, the discharging circuit 510 of the capacitor energy release circuit 51 of the power supply 5 has a single discharging terminal 51a. The discharging circuit 510 is connected to the positive output terminal 200a of the rectifying circuit 200. In addition, the discharging circuit 510 is also connected to the first current-conducting terminal 211a of the switching circuit 211. In a case that the AC voltage V_{ac} is received by the power supply 5, the electric energy stored in the filter capacitor C₂ is firstly transmitted to the rectifying circuit 200 to be rectified into a DC voltage, which is then discharged to the discharging loop defined by the capacitor energy release circuit 51 through the discharging terminal 51a.

During the electric energy stored in the filter capacitor C₂ is discharged, the electric energy is transmitted to the rectifying circuit 200 and rectified into a DC voltage by the rectifying circuit 200. Since the electric energy stored in the filter capacitor C₂ is transmitted to the rectifying circuit 200, only the discharging terminal 51a is required. In contrast, as shown in FIG. 3, since the energy stored in the filter capacitor C₂ is not transmitted to the rectifying circuit 200, the discharging circuit 210 needs the first discharging terminal 21b and the second discharging terminal 21c to receive the AC voltage. As such, the first discharging diode D₁ and the second discharging diode D₂ included in the discharging circuit 210 of FIG. 3 can be omitted while retaining the discharging resistor R₉.

Please refer to FIG. 4 again. The main circuit 20 further comprises an energy storage unit, e.g. an energy storage capacitor C₇. The positive input terminal of the energy storage capacitor C₇ is connected to the discharging terminal 51a of the capacitor energy release circuit 51. The transition DC voltage Vᵢₘ outputted from the rectifying circuit 200 can be stabilized by the energy storage capacitor C₇.

Since the energy storage capacitor C₇ is connected to the discharging terminal 51a of the capacitor energy release circuit 51, if the AC voltage V_{ac} is not received by the power input terminal 2a of the power supply 5, the electric energy stored in the filter capacitor C₂ and the electric energy stored in the energy storage capacitor C₇ may be discharged through the discharging loop of the capacitor energy release circuit 51.

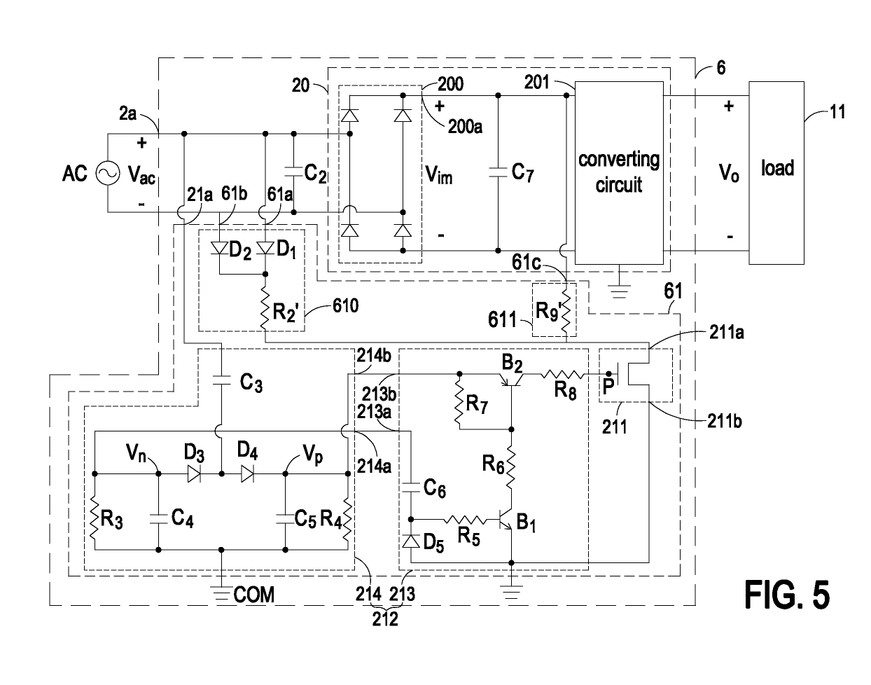

FIG. 5 is a schematic detailed circuit diagram illustrating a power supply according to a third embodiment of the present invention. In comparison with FIG. 4, the capacitor energy release circuit 61 of the power supply 6 comprises a first discharging circuit 610 and a second discharging circuit 611. The first discharging circuit 610 has a first discharging terminal 61a and a second discharging terminal 61b. The first discharging circuit 610 comprises a first discharging diode D₁, a second discharging diode D₂ and a first discharging resistor R₂′. The first discharging terminal 61a and the second discharging terminal 61b are respectively connected to the positive terminal and the negative terminal of the filter capacitor C₂. Once the switching circuit 211 is conducted, a discharging loop is defined by the first discharging circuit 610 and the switching circuit 211. As such, the electric energy stored in the filter capacitor C₂ is discharged to the discharging loop. The configurations of the first discharging circuit 610 are similar to those shown in FIG. 3, and are not redundantly described herein.

The second discharging circuit 611 comprises a third discharging terminal 61c and a second discharging resistor R₉′. The third discharging terminal 61c is connected to the positive input terminal of the energy storage capacitor C₇. The second discharging resistor R₉′ is connected to the third discharging terminal 61c and the first current-conducting terminal 211a of the switching circuit 211. Once the switching circuit 211 is conducted, another discharging loop is defined by the second discharging circuit 611 and the switching circuit 211. As such, the electric energy stored in the energy storage capacitor C₇ is discharged to the discharging loop.

In a case that the AC voltage V_{ac} is not received by the power supply 6, a discharging loop is defined by the first discharging circuit 610 of the capacitor energy release circuit 61 and the switching circuit 211. As such, the electric energy stored in the filter capacitor C₂ is discharged to the discharging loop. At the same time, another discharging loop is defined by the second discharging circuit 611 and the switching circuit 211. As such, the electric energy stored in the energy storage capacitor C₇ is discharged to the discharging loop. By the first discharging circuit 610 and the second discharging circuit 611, the electric energy stored in the filter capacitor C₂ and the electric energy stored in the energy storage capacitor C₇ will be discharged through respective discharging loops in order to increase the discharging speed.

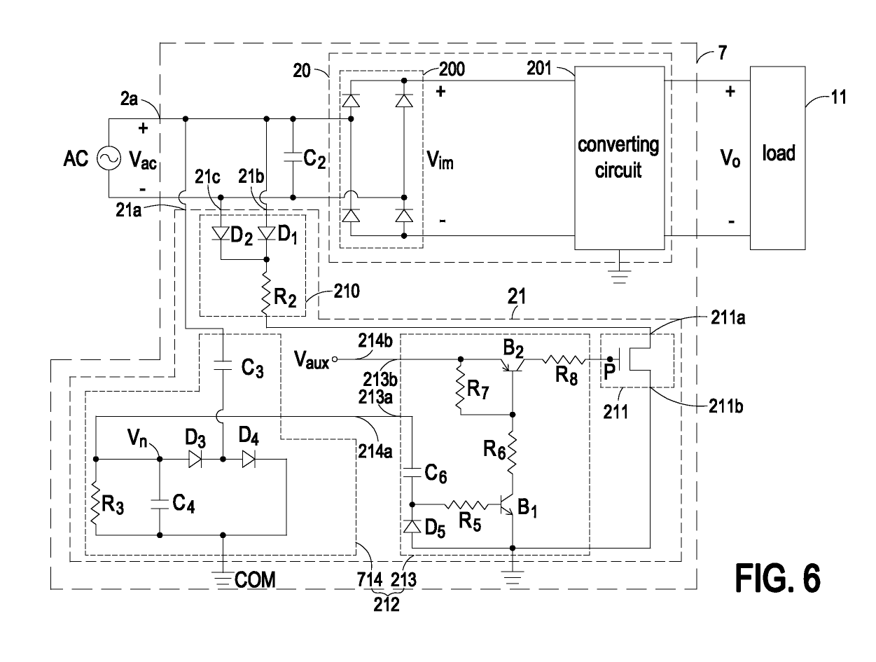

FIG. 6 is a schematic detailed circuit diagram illustrating a power supply according to a fourth embodiment of the present invention. In comparison with FIG. 3, the second input terminal 213b of the driving circuit 213 is connected to an auxiliary voltage Vₐᵤₓ. As such, the emitter of the PNP bipolar junction transistor B₂ of the driving circuit 213 is connected to the auxiliary voltage Vₐᵤₓ through the second input terminal 213b. When the AC voltage V_{ac} is received by the power supply 7, a portion of electric energy of the AC voltage V_{ac} may be stored and a constant positive voltage is provided by the auxiliary voltage Vₐᵤₓ to power components within the power supply 7.

In a case that the AC voltage V_{ac} is not received by the power input terminal 2a of the power supply 7, the NPN bipolar junction transistor B₁ and the PNP bipolar junction transistor B₂ are conducted in response to the first detecting signal Vₙ. As such, the auxiliary voltage Vₐᵤₓ is transmitted to the control terminal P of the switching circuit 211 through the PNP bipolar junction transistor B₂. According to the auxiliary voltage Vₐᵤₓ, the switching circuit 211 is conducted. As such, a discharging loop is defined by the discharging resistor R₂ of the first discharging circuit 210 and the switching circuit 211, and the electric energy stored in the filter capacitor C₂ may be quickly discharged to the discharging loop so as to meet the safety regulations.

Since the switching circuit 211 is driven to be conducted by the auxiliary voltage Vₐᵤₓ, the third voltage-dividing capacitor C₅ and the second voltage-regulating resistor R₄ included in the AC voltage detecting circuit 214 of FIG. 3 are omitted in the AC voltage detecting circuit 714 of this embodiment. That is, the second output terminal 214b is also omitted. In this embodiment, the second rectifying diode D₄ is interconnected between the first voltage-dividing capacitor C₃ and the common terminal COM.

From the above description, the capacitor energy release circuit has reduced power consumption. Since the discharging loop is dynamically created by the capacitor energy release circuit, the power consumption of the power supply is reduced in order to enhance the power-saving efficacy. In addition, the power supply having the capacitor energy release circuit can meet safety regulations.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply interconnected between an AC power source and a load, said AC power source outputting an AC voltage, said power supply comprising:
a power input terminal for receiving said AC voltage;
a filtering unit connected to said power input terminal for filtering off noise contained in said AC voltage;
a main circuit connected to said filtering unit and said load, wherein said AC voltage is filtered by said filtering unit and converted into an output DC voltage by said main circuit, and said output DC voltage is transmitted to said load; and
a capacitor energy release circuit connected to said power input terminal, said filtering unit and a common terminal for detecting whether said AC voltage is received by said power input terminal, wherein when said AC voltage is not received by said power input terminal, electric energy stored in said filtering unit is discharged.

2. The power supply according to claim 1 wherein said capacitor energy release circuit comprises:
a switching circuit comprising a first current-conducting terminal and a second current-conducting terminal, wherein said second current-conducting terminal is connected to said common terminal;
a discharging circuit connected to said filtering unit and said first current-conducting terminal of said switching circuit, wherein when said switching circuit is conducted, electric energy stored in said filtering unit is discharged by said discharging circuit; and
a discharging loop controller connected to said power input terminal and a control terminal of said switching circuit for detecting whether said AC voltage is received by said power input terminal, wherein under control of said discharging loop controller, said switching circuit is shut off if said AC voltage is received by said power input terminal, or said switching circuit is conducted if said AC voltage is not received by said power input terminal.

3. The power supply according to claim 2 wherein said discharging circuit comprises:
a first discharging diode connected to a positive input terminal of said filtering unit;
a second discharging diode connected to a negative input terminal of said filtering unit; and
a discharging resistor connected to said first discharging diode, said second discharging diode and said first current-conducting terminal of said switching circuit.

4. The power supply according to claim 2 wherein said discharging loop controller comprises an AC voltage detecting circuit for detecting whether said AC voltage is received by said power input terminal, and generating a first detecting signal according to the detecting result.

5. The power supply according to claim 4 wherein if said AC voltage is received by said power input terminal, said first detecting signal has a negative value, and if said AC voltage is not received by said power input terminal, said first detecting signal is increased from said negative value to zero.

6. The power supply according to claim 4 wherein said discharging loop controller further comprises a driving circuit, which is connected to said control terminal of said switching circuit, said AC voltage detecting circuit and said common terminal for receiving said first detecting signal and a second detecting signal, and controlling operations of said switching circuit according to said first detecting signal, wherein if said driving circuit detects that said AC voltage is received by said power input terminal according to said first detecting signal, said switching circuit is shut off under control of said driving circuit, and if said driving circuit detects that said AC voltage is not received by said power input terminal according to said first detecting signal, said second detecting signal is transmitted to said control terminal of said switching circuit under control of said driving circuit, so that said switching circuit is conducted.

7. The power supply according to claim 6 wherein said AC voltage detecting circuit comprises:
a first voltage-dividing capacitor connected to said power input terminal;
a first rectifying diode connected to said first voltage-dividing capacitor; and
a second voltage-dividing capacitor connected to said first rectifying diode,
wherein if said AC voltage is received by said power input terminal during a negative half-cycle period, said AC voltage passes through said first voltage-dividing capacitor and said first rectifying diode to charge said second voltage-dividing capacitor, so that said second voltage-dividing capacitor generates said first detecting signal.

8. The power supply according to claim 7 wherein said AC voltage detecting circuit further comprises:
a second rectifying diode connected to said first voltage-dividing capacitor; and
a third voltage-dividing capacitor connected to said second rectifying diode,
wherein if said AC voltage is received by said power input terminal during a positive half-cycle period, said AC voltage passes through said first voltage-dividing capacitor and said second rectifying diode to charge said third voltage-dividing capacitor, so that said third voltage-dividing capacitor generates said second detecting signal.

9. The power supply according to claim 8 wherein said AC voltage detecting circuit further comprises:
a first voltage-regulating resistor connected to said second voltage-dividing capacitor for regulating the voltage level of said first detecting signal; and
a second voltage-regulating resistor connected to said third voltage-dividing capacitor for regulating the voltage level of said second detecting signal.

10. The power supply according to claim 8 wherein said driving circuit comprises:
a pulse capacitor connected to said second voltage-dividing capacitor for receiving said first detecting signal;
a voltage-difference diode having both terminals respectively connected to said pulse capacitor and said common terminal;
a first current-limiting resistor connected to said pulse capacitor;
an NPN bipolar junction transistor having a base connected to said first current-limiting resistor and a emitter connected to said common terminal;
a second current-limiting resistor connected to a collector of said NPN bipolar junction transistor; and
a PNP bipolar junction transistor having a base connected to said second current-limiting resistor, an emitter connected to said second current-limiting resistor and a collector connected to said control terminal of said switching circuit,
wherein if said AC voltage is received by said power input terminal, said first detecting signal pass through said pulse capacitor and said first current-limiting resistor to drive said NPN bipolar junction transistor and said PNP bipolar junction transistor to be in an off state, so that said switching circuit is shut off, wherein if said AC voltage is not received by said power input terminal, said first detecting signal is converted into a positive pulse signal by said pulse capacitor, and said NPN bipolar junction transistor and said PNP bipolar junction transistor are conducted in response to said positive pulse signal, so that said second detecting signal passes through said PNP bipolar junction transistor to drive said switching circuit to be conducted.

11. The power supply according to claim 10 wherein said driving circuit further comprises:
a third voltage-regulating resistor interconnected between said base and said emitter of said PNP bipolar junction transistor for stabilizing operations of said PNP bipolar junction transistor; and
a fourth voltage-regulating resistor interconnected between said collector of said PNP bipolar junction transistor and said control terminal of said switching circuit for stabilizing operations of said switching circuit.

12. The power supply according to claim 6 wherein said second detecting signal is outputted from said AC voltage detecting circuit, wherein if said AC voltage is received by said power input terminal, said second detecting signal has a positive value, and if said AC voltage is not received by said power input terminal, said second detecting signal is decreased from said positive value to zero.

13. The power supply according to claim 4 wherein said discharging loop controller further comprises a driving circuit, which is connected to said control terminal of said switching circuit, said AC voltage detecting circuit and said common terminal for receiving said first detecting signal and an auxiliary voltage, and controlling operations of said switching circuit according to said first detecting signal, wherein if said driving circuit detects that said AC voltage is received by said power input terminal according to said first detecting signal, said switching circuit is shut off under control of said driving circuit, and if said driving circuit detects that said AC voltage is not received by said power input terminal according to said first detecting signal, said auxiliary voltage is transmitted to said control terminal of said switching circuit under control of said driving circuit, so that said switching circuit is conducted.

14. The power supply according to claim 2 wherein said main circuit comprises:
a rectifying circuit connected to said filtering unit, wherein said AC voltage is filtered by said filtering unit and converted into a transition DC voltage by said rectifying circuit; and
a converting circuit interconnected between said rectifying circuit and said load for receiving said transition DC voltage and converting said transition DC voltage into said output DC voltage.

15. The power supply according to claim 1 wherein said filtering unit includes a filter capacitor.

16. A power supply interconnected between an AC power source and a load, said AC power source outputting an AC voltage, said power supply comprising:
a power input terminal for receiving said AC voltage;
a filtering unit connected to said power input terminal for filtering off noise contained in said AC voltage;
a main circuit connected to said filtering unit and said load, and comprising a rectifying circuit, wherein said AC voltage is filtered by said filtering unit and converted into an output DC voltage by said main circuit, and said rectifying circuit is connected to said filtering unit for rectifying said AC voltage into a transition DC voltage; and
a capacitor energy release circuit connected to said power input terminal, said filtering unit and a common terminal for detecting whether said AC voltage is received by said power input terminal, wherein when said AC voltage is not received by said power input terminal, electric energy stored in said filtering unit is discharged.

17. The power supply according to claim 16 wherein said capacitor energy release circuit comprises:
a switching circuit comprising a first current-conducting terminal and a second current-conducting terminal, wherein said second current-conducting terminal is connected to said common terminal;
a discharging circuit connected to said rectifying unit and said first current-conducting terminal of said switching circuit, wherein when said switching circuit is conducted, electric energy stored in said filtering unit is discharged by said discharging circuit; and
a discharging loop controller connected to said power input terminal and a control terminal of said switching circuit for detecting whether said AC voltage is received by said power input terminal, wherein under control of said discharging loop controller, said switching circuit is shut off if said AC voltage is received by said power input terminal, or said switching circuit is conducted if said AC voltage is not received by said power input terminal.

18. The power supply according to claim 16 wherein said capacitor energy release circuit comprises a discharging resistor, which is connected to said rectifying circuit and said first current-conducting terminal of said switching circuit.

19. The power supply according to claim 16 wherein said main circuit further comprises an energy storage unit interconnected between said rectifying circuit and said load and connected to said capacitor energy release circuit for stabilizing said transition DC voltage, wherein if said AC voltage is not received by said power input terminal, electric energy stored in said energy storage unit is discharged by said capacitor energy release circuit.

20. The power supply according to claim 19 wherein said capacitor energy release circuit comprises:
a switching circuit comprising a first current-conducting terminal and a second current-conducting terminal, wherein said second current-conducting terminal is connected to said common terminal;
a first discharging circuit connected to said rectifying unit and said first current-conducting terminal of said switching circuit, wherein when said switching circuit is conducted, electric energy stored in said filtering unit is discharged by said first discharging circuit;
a second discharging circuit connected to said rectifying unit, a positive input terminal of said energy storage unit and said first current-conducting terminal of said switching circuit, wherein when said switching circuit is conducted, electric energy stored in said filtering unit is discharged by said second discharging circuit; and
a discharging loop controller connected to said power input terminal and a control terminal of said switching circuit for detecting whether said AC voltage is received by said power input terminal, wherein under control of said discharging loop controller, said switching circuit is shut off if said AC voltage is received by said power input terminal, or said switching circuit is conducted if said AC voltage is not received by said power input terminal.

21. A capacitor energy release circuit for use in a power supply, said power supply having a power imputer terminal connected to an AC power source and having a filtering unit, said capacitor energy release circuit comprising:
a switching circuit comprising a first current-conducting terminal and a second current-conducting terminal, wherein said second current-conducting terminal is connected to a common terminal;
a discharging circuit connected to said filtering unit and said first current-conducting terminal of said switching circuit, wherein when said switching circuit is conducted, electric energy stored in said filtering unit is discharged by said discharging circuit; and
a discharging loop controller connected to said power input terminal and a control terminal of said switching circuit for detecting whether said AC voltage is received by said power input terminal, wherein under control of said discharging loop controller, said switching circuit is shut off if said AC voltage is received by said power input terminal, or said switching circuit is conducted if said AC voltage is not received by said power input terminal.
